(19) United States
(12) Patent Application Publication
(10) Pub. No.: US 2016/0257327 A1
(43) Pub. Date: Sep. 8, 2016

(54) Collapsible Utility Cart

(71) Applicants: Raymond James Gayk, JR., Menifee, CA (US); Dawn Ellen Gayk, Menifee, CA (US)

(72) Inventors: Raymond James Gayk, JR., Menifee, CA (US); Dawn Ellen Gayk, Menifee, CA (US)

(21) Appl. No.: 14/635,521

(22) Filed: Mar. 2, 2015

(51) Int. Cl. B62B 1/12

(52) U.S. Cl. CPC B62B 1/12

(57) ABSTRACT

A collapsible utility cart (CUC) having a base, an axle and wheel assembly, a lower structure and an upper structure. The axle and wheel assembly is attached to the base, and the base extends forward from a lower end of the lower structure. The base can fold upward to a position interfacing with and parallel to the lower structure. The base is pivotally attached to the lower structure, and the lower structure is pivotally attached to the upper structure by right and left U-shaped connectors. Also attached to the upper structure are a handle assembly and a tray assembly. The CUC can be used to simultaneously transport a variety of multiple items, and when not in use, can be collapsed to a small size for transportation and storage of the CUC.

### TECHNICAL FIELD

The invention generally pertains to wheeled carts, and more particularly to a collapsible utility cart that can transport a variety of multiple items and when not in use, can be folded into a compact easily-managed size.

### BACKGROUND ART

One of the oldest and widely-used inventions of mankind is a wheeled structure for transporting items. Commonly, a wheeled structure is referred to as a cart. Depending on the requirement(s), a cart can be made in various configurations and sizes. Most carts include at least two wheels and are either utilized/maneuvered by a person(s) or attached to a vehicle.

There are carts that are specially designed for a specific purpose. For example, there are heavy duty carts for use with construction equipment or building materials, and there are lightweight, relatively smaller carts for use by individuals to transport personal items. While the heavy duty carts can be used to transport smaller and lighter items, the lightweight smaller carts can not typically be used to transport large and/or heavy items. Also, the design of many carts, which consists of a single open box-like structure into which items are placed and often piled on top of each other, is not optimal for multiple items with a variety of shapes.

In addition to carts, one of the most effective devise for transporting items including large heavy items is known as a dolly. The main benefit of a dolly is that once an item is placed on it, the item and the dolly can be tilted backward. By altering the angle, the center of gravity is shifted, thereby allowing even large heavy items to be easily transported by a single person.

It would be very beneficial to provide a cart into or onto which a variety of multiple items could be placed and secured. The cart would have at least two wheels and could be angled backward in the same manner as a dolly. Optimally, the cart could be collapsed into a smaller size for storage and transportation or the cart. A cart with this functionality, that is capable of transporting both lightweight small item as well as larger heavier items, would be significantly helpful to many people who often or less-frequently need to transport items, from one location to another.

A search of the prior art did not disclose any literature or patents that read directly on the claims of the instant invention. However, the following U.S. patents are considered related:

| PATENT NO. | INVENTOR | ISSUED |
|---|---|---|
| 2,901,262 | Berlin | 25 Aug. 1959 |
| 3,804,432 | Lehrman | 16 Apr. 1974 |
| 4,537,421 | Teachout | 27 Aug. 1985 |
| 4,865,346 | Carlile | 12 Sep. 1989 |
| 5,626,352 | Grace | 6 May 1997 |
| 6,113,129 | Marques et al | 5 Sep. 2000 |

The U.S. Pat. No. 2,901,262 discloses a collapsible multi-tier laundry cart commonly used to receive, store and transport articles or parcels during marketing or laundry activities.

The U.S. Pat. No. 3,804,432 discloses a collapsible cart having upper and lower supports which may be moved between operative and in-operative positions. A laundry basket or the like may be supported one ach support. A utility receptacle may also be secured to the collapsible cart

The U.S. Pat. No. 4,537,421 discloses a foldable dolly in which arms are rotatably mounted to the frame preferably by means of inter-engaging sleeves formed with opposed ramps and opposed shoulders and positioned in relatively vertical alignment. The ramps and shoulders of the first sleeve mate with the ramps and shoulders of the second sleeve. The sleeves are thereby found to permit rotation of the arms between a folded, collapsed position and an extended deployed position.

The U.S. Pat. No. 4,865,346 discloses a hand-propelled cart assembly for use in support of activities such as picnicking or beach-going. The cart includes a separable wheeled frame having an upright section comprising upper and lower portions. A foldable shelf member on the lower portion supports a cooler chest and is provided with elements precluding lateral shifting of the chest during movement of the cart. A pair of swingable arms on the lower portion accommodate one or more seating members such as folding chairs while receiver elements retain an umbrella and rink receptacles. The upper portion of the upright section supports a container having a fold down serving shelf adjacent an accessory panel presenting a radio, thermometer; clock and the like. A further receptacle, in the form of a closable bag is affixed behind the container.

The U.S. Pat. No. 5,626,352 disclose a collapsible, foldable cart, having a frame with spaced-apart first and second longitudinal frame members defining a plane, and a pair of wheels and a wheel axle connected to the frame. The cart has two foldable shelf members pivotally connected to the frame which are movable between a first position for carrying a load on the shelf member, and a second position wherein the shelf member is disposed in a vertical plane and is between the first and second longitudinal frame members. The cart also includes a handle section pivotally connected to the frame. The cart further includes a bottom-most stabilizing shelf member pivotally connected to the frame and movable between a first position of carrying a load on the stabilizing shelf member and a second position wherein the stabilizing shelf member is folded towards the frame to fold-up and collapse the cart.

The U.S. Pat. No. 6,113,129 discloses a wheeled beach cart including a wheeled framework member, a support leg member pivotally associated with the lower end of the framework member and dimensioned to support a beverage cooler and a beach chair support unit rotatably associated with the upper portion of the framework member. The beach chair support unit includes a pair of extendable and retractable support arm member slidably disposed on a cross-piece element rotatably suspended in the framework member.

For background purposes and indicative of the art to which the invention relates, reference may be made to the following remaining patents found in the patent search.

| PATENT NO. | INVENTOR | ISSUED |
|---|---|---|
| D456,973 | Kimpel | 7 May 2002 |
| 3,052,484 | Huffman et al | 4 Sep. 1962 |
| 5,207,439 | Mortenson | 4 May 1993 |
| 5,333,885 | Pullman | 2 Aug. 1994 |
| 5,915,723 | Austin | 29 Jun. 1999 |
| 6,880,851 | Summers et al | 19 Apr. 2005 |
| 6,883,267 | Pruitt | 26 Apr. 2005 |
| 7,083,174 | Kane | 1 Aug. 2006 |
| 7,320,470 | Butera | 22 Jan. 2008 |
| 2001/0045715 | Abraham et al | 29 Nov. 2001 |

### DISCLOSURE OF THE INVENTION

The collapsible utility cart (CUC) is designed to allow a single person to easily transport a variety of multiple items. The CUC is especially effective for transporting items used during a picnic or other similar activity. A relatively large cooler/ice chest, as well as other items such as cooking utensils, sporting equipment and folding chairs can also be loaded onto the CUC and simultaneously transported. The CUC even provides a means for securing and transporting a folding umbrella along with the other items.

In addition to the ability of simultaneously transporting a variety of multiple items, the CUC's other main advantage is that it can be collapsed to a small size for transportation and storage of the CUC. When the CUC is collapsed, it can easily be carried by a single person and placed in a location such as a car trunk. When needed for use, the CUC can quickly and easily be assembled into its functional configuration.

In its basic design, the CUC, which is preferably made of metal, is comprised of a base, an axle and wheel assembly, a lower structure and an upper structure. The axle and wheel assembly is attached to the rear of the base, and the base extends forward perpendicularly from the lower end of the lower structure. The base can fold upward to a position interfacing with and parallel to the lower structure. The lower structure has lower left and lower right vertical tubes and a lower horizontal tube. The upper structure has upper left and upper right vertical tubes and an upper horizontal tube. The lower structure is pivotally attached to the upper structure by right and left U-shaped connectors. The upper structure folds downward to a position interfacing with the lower structure.

The upper structure can also include a handle assembly and a tray assembly. The handle assembly extends rearward substantially perpendicular from the upper end of the upper structure. The tray assembly is pivotally attached to and extends perpendicularly forward form the upper structure. The tray assembly can fold downward to a position interfacing with and parallel to the lower half of the upper structure.

When all the CUC's components are all in their respective upward or downward folded positions, the CUC is a substantially square, flat structure that can be placed in various locations for storage or transportation. For use, the CUC's components are un-folded into their functional positions. Not all of the CUC's components must be utilized. For example, if a person is only transporting a cooler/ice chest, then only the base would be necessary, the tray assembly could remain in its folded position or removed from the CUC. When the tray assembly remains in its downward folded position or removed, items can be stacked on top of each other from the base. The tray is especially useful during events such as a bar-b-que, when the CUC can be placed next to the bar-b-que to provide access to items that are conveniently located at a height which does not require bending or stooping.

The CUC is durably constructed to provide years of use. The construction of the CUC also insures that the CUC will not be damaged from transporting many different types and sizes of items.

In view of the above disclosure, the primary object of the invention is to, provide a collapsible utility cart that can simultaneously transport a variety of multiple items, and when not in use, can be collapsed to a small, easy to carry and store size.

In addition to the primary object, it is also an object of the invention to provide a collapsible utility cart that:
is durable and well made,
is easy to assemble for use and to collapse for storage or transportation,
can be made in various sizes,
can be used, assembled and collapsed by a single person,
when collapsed, can fit into almost any car trunk,
can be used in a variety of environments, such as a beach, mountains or urban areas,
can be used by emergency personnel/first responders,
can be placed within a small enclosure or hung on a wall when not in use
is cost effective from both a manufacturer's and consumer's point of view.

These and other objects and advantages of the present invention will become apparent from the sub sequent detailed description of the preferred embodiment and the appended claims taken in conjunction with the accompanying drawings.

### BRIEF DESCRIPTION OF THE DRAWINGS

FIG. 1 is a front orthographic view of a collapsible utility cart (CUC) in an assembled, ready for use configuration.

FIG. 2 is a rear orthographic view of the CUC in an assembled, ready for use configuration,

FIG. 3 is a front view of the CUC in the assembled, ready for use configuration.

FIG. 4 is a right side view of the CUC in the assembled, ready for use configuration.

FIG. 5 is a front orthographic view of the CUC with a tray assembly having an upward pivoted first inner tray surface and an upward pivoted second outer tray surface.

FIG. 6 is a rear view of the CUC with an upper structure folded onto and interfacing with a lower structure.

FIG. 7 is a rear orthographic view of the CUC with the upper structure folded onto and interfacing with the lower structure.

FIG. 8 is a front view of the CUC in a collapsed, folded substantially flat configuration parallel to the ground.

FIG. 9 is a left side view of the CUC in a collapsed, folded substantially flat configuration and extending upward perpendicular to the ground.

### BEST MODE FOR CARRYING OUT THE INVENTION

The best mode for carrying out the invention is presented in terms that disclose a preferred embodiment of a collapsible utility cart (CUC 10). Designed for many uses and applications, the CUC 10 allows a single person to simultaneously transport a variety of multiple items over different surfaces. The CUC 10 is especially effective for transporting items used in outdoor activities such as a bar-b-que, sporting events, or family get together. The CUC 10 can easily be loaded with items such as a relatively large cooler/ice chest, multiple folding chairs and even an umbrella. By the use of a removable tray, the CUC 10 can also be used to hold or maintain items at a convenient height during certain activities such as cooking.

When the CUC is transported or stored, it can be collapsed to a substantially flat, square structure that can be easily carried and placed into a car trunk or other areas with limited space. For use, the CUC 10 can be quickly and easily assembled into its functional position by performing simple steps.

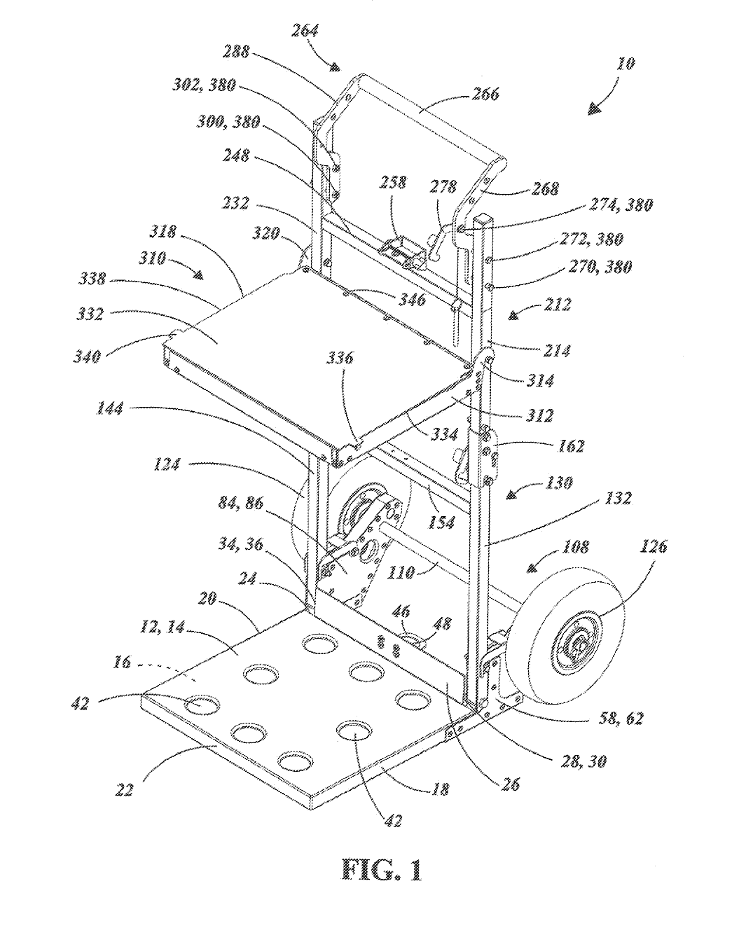

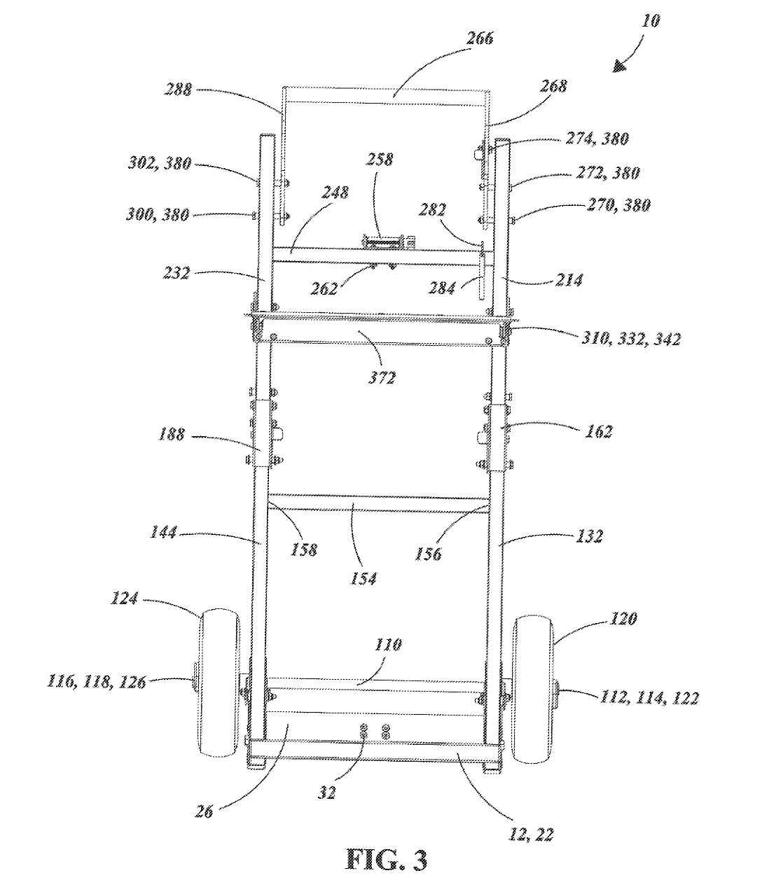

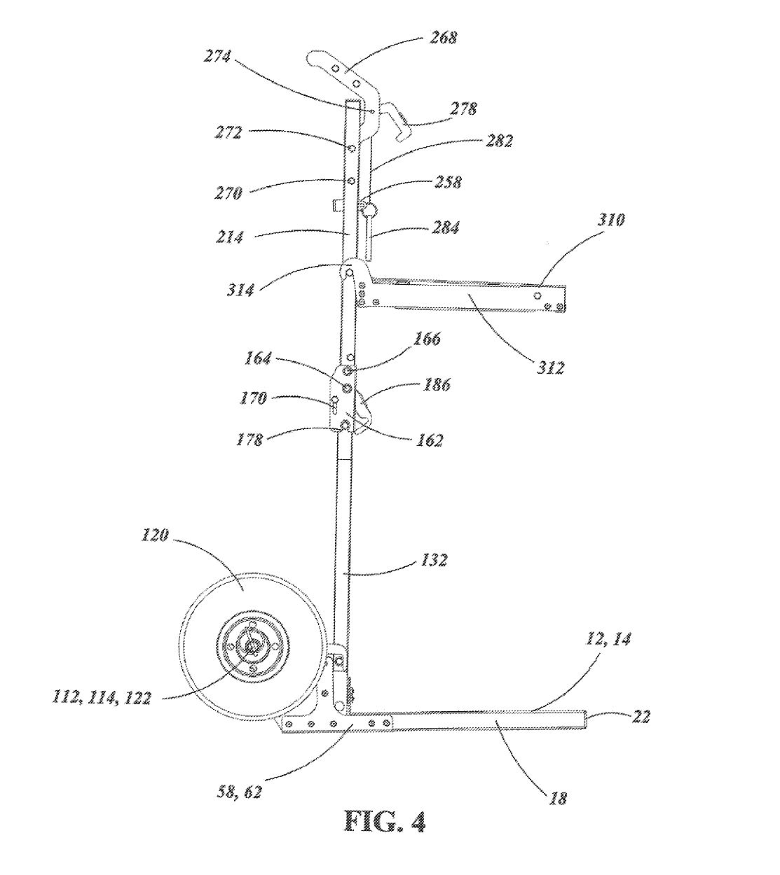

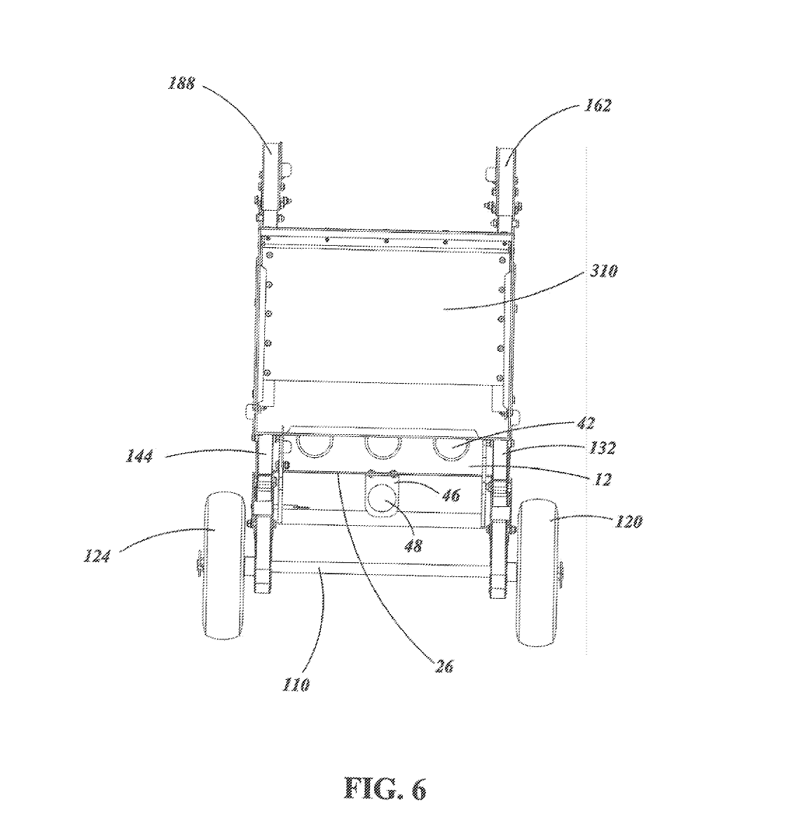

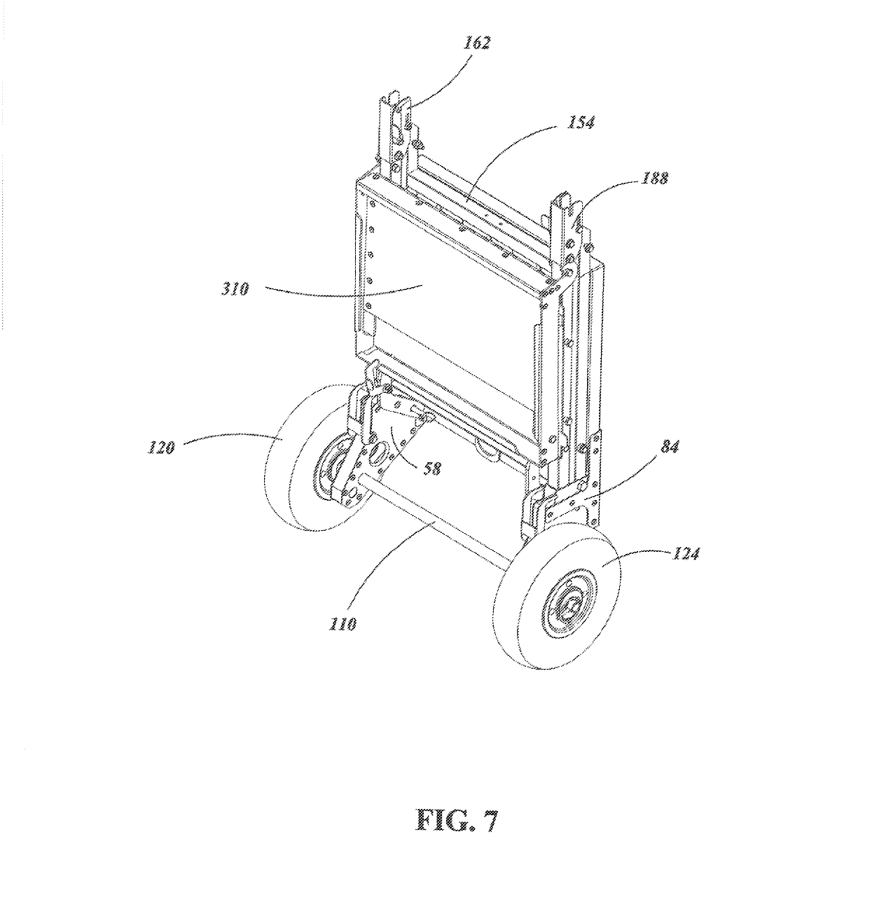

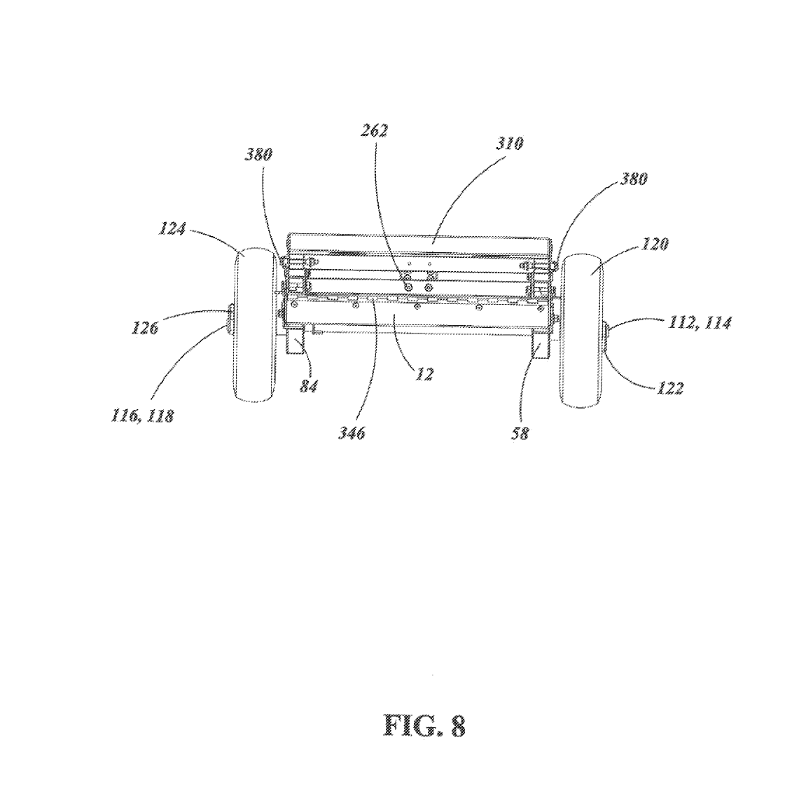

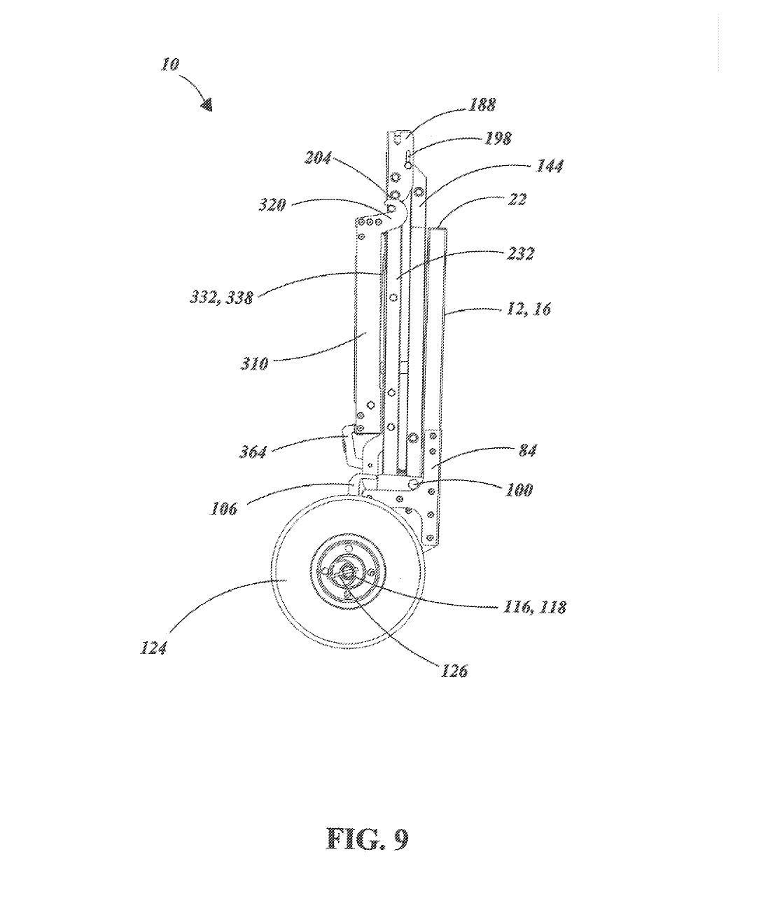

As shown in FIGS. 1-9, the CUC 10 is comprised of the following major elements: a base 12, a right axle structure 58; a left axle structure 84; an axle and wheel assembly 108; a lower structure 130 having a lower right vertical tube 132, a lower left vertical tube 144 and a lower horizontal tube 154; an upper structure 212 having an upper right vertical tube 214, an upper left vertical tube 232 and an upper horizontal tube 248; a handle assembly 264; and a tray assembly 310.

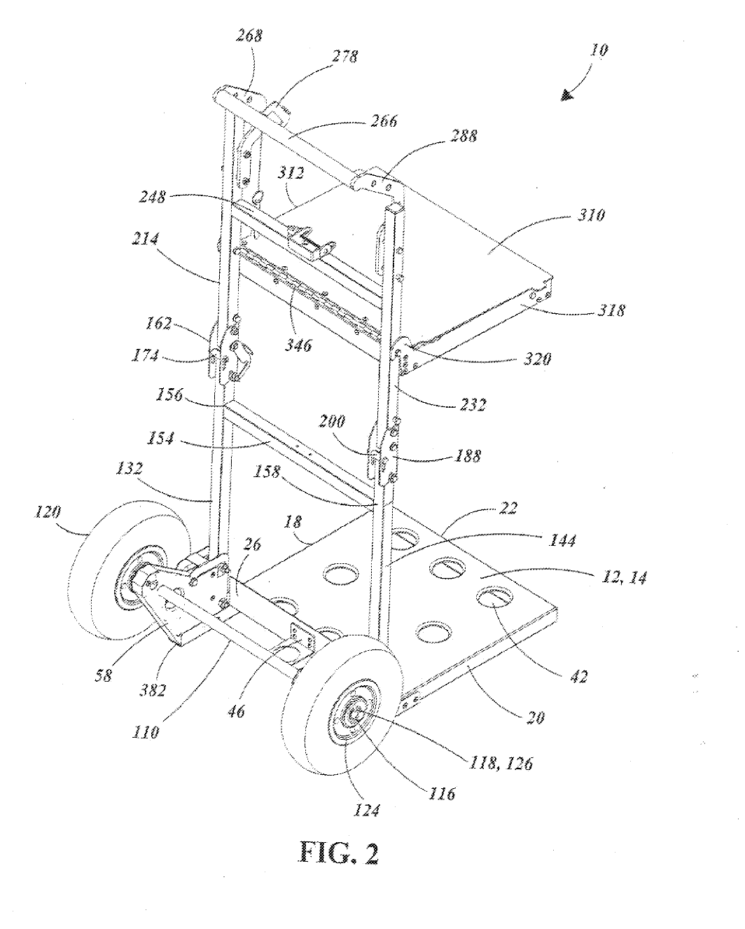

As shown in FIGS. 1-9, the base 12, which is preferably made of one-inch tubing, has an upper surface 14, a lower surface 16, a right edge 18, a left edge 20, a front edge 22 and a rear edge 24. Extending upward from and integrally attached to the rear edge 24 is a vertical plate 26 having a right end 28 with a right bend 30 and a bore 32 therethrough, and a left end 34 with a left bend 36 and a bore 38 therethrough. Located on and extending through the upper surface 14 of the base 12 is at least one weight reduction opening 42, as best shown in FIGS. 1 and 2. Extending inward from the vertical plate 26 is a storage bracket 46 having an opening 48 and at least one attachment bore 50 into which is inserted a corresponding nut and bolt combination 380 which extends through the vertical plate 26. Optionally, two casters (not shown) can be attached to the front edge 22 of the base 12. An additional third opening can be located on a lower section of each axle plate and is utilized to place a round axle rod through each opening and attach two tires onto the axle. In this position the cart is raised and no longer rests on the base. Since the cart has been lifted approximately 4 inches in the rear, in this position, two casters are placed on the front of the base to level the cart. This design transforms the cart from a two wheel lean back dolly style cart to a four wheel push cart similar to a shopping cart. Both of the casters are mounted on a 1 inch piece of square tube and placed under the base of the cart. The casters are attached to the base with two quick release pins (not shown) so the caster assembly can be attached or removed quickly. Additionally, this wheels/tires and casters configuration facilitates the placement of large tool boxes or other containers on the base 12 while using the tray assembly 310, without having to tilt the CUC 10 back to move the CUC 10.

The right axle structure 58, as shown in FIGS. 1, 2, 6 and 7, has an inner side plate 60, an outer side plate 62 and a downward sloping central section 64. The two side plates are configured to create a U-shaped opening, as shown in FIGS. 1 and 2. The downward sloping central section is located between and attached to the inner and outer side plates 60,62. Extending through the inner and outer side plates 60,62 is at least one axle bore 66, a first bore 72, a second bore 74, and a pin bore 80. Extending through the first bore 72 is a nut and bolt combination 380 that pivotally secures a right lower latch 76.

The left axle structure 84, as shown in FIGS. 1, 2, 6 and 7, has an inner side plate 86, an outer side plate 88 and a downward sloping central section 90. The two side plates are configured to create a U-shaped opening. The downward sloping central section 90 is located between and attached to the inner and outer side plates 86,88. Extending through the inner and outer side plates 86,88 is at least one axle bore 96, a first bore 98 and a second bore 100. Extending through the first bore 98 is a nut and bolt combination 380 that pivotally secures a left lower latch 106. The elements right axle structure 58 and the left axle structure 84 are attached together either by riveting, as shown in FIG. 1, or, preferably by an alternate attachment means such as welding, as shown in FIG. 2.

The axle and wheel assembly 108, as shown in FIGS. 1, 2, 3, 5 and 7, comprises an axle 110 having a right end 112 with a bore 114 therethrough and a left end 116 with a bore 118 therethrough. The axle 110 is made of a strong, durable material such as metal. Preferably, the axle 2110 is made of 14 gauge stainless steel. The axle and wheel assembly 108 is located at the bottom rear of the CUC 10. The right end 112 of the axle 110 is inserted through the axle bore 66 on the right axle structure 58 and the left end 116 is inserted through the axle bore 96 on the left axle structure 84. A right wheel/tire 120 is attached to the axle 110 by inserting the right end 112 through a bore in the center of the right wheel, and inserting a right axle pin 122, which secures the right wheel/tire 120 through the bore 114 on the right end 112. A left wheel/tire 124 is attached to the axle 110 by inserting the left end 116 through a bore in the center of the left wheel, and inserting a left axle pin 126, which secures the left wheel/tire 124 through the bore 118 on the left end 116.

A lower structure 130 comprises the lower right vertical tube 132, the lower left vertical tube 144, and the lower horizontal tube 154. The lower right vertical tube 132, as shown in FIGS. 1, 2, 3 and 5, has a first bore 134, a second bore 136 and a third bore 138. The lower right vertical tube 132 extends upward from the right side of the base 12 and a lower section of the tube 132 is located in a U-shaped opening created by the right axle structure's two side plates 60,62. A nut and bolt combination 380 is inserted through the second bore 74 on the right axle structure 58 and through the first bore 134 on the lower right vertical tube 132 to pivotally attach the tube 132 to the right axle structure 58.

The lower left vertical tube 144, as shown in FIGS. 1, 2, 3 and 5, has a first bore 146, a second bore 148 and a third bore 150. The lower left vertical tube 144 extends upward from the left side of the base 12 and a lower section of the tube 144 is located in a U-shaped opening created by the left axle structure's two side plates 86,88. A nut and bolt combination 380 is inserted through the second bore 100 on the left axle structure 84 and through the first bore 146 on the lower left vertical tube 144 to pivotally attach the tube to the left axle structure 84. Located adjacent the upper ends of the lower right and left vertical tubes 132,144 is the lower horizontal tube 154 having a right end 156 and a left end 158. The right end 156 of the horizontal tube 154 is attached to the lower right vertical tube 132, and the left end 158 is attached to the lower left vertical tube 144.

As shown in FIGS. 1, 2, 3, 5, 6 and 7, located at the bottom of the lower right vertical tube 132 is a right U-shaped connector 162 having a first bore 164, a second bore 166, an upper right slot 170, an upper left slot 172, a right pivitor 174, a lower right U-slot 176, a lower left U-slot 178, an upper end 182, a lower end 184, and a right securing latch 186 having a bore therethrough and that is pivotally attached by nut and bolt combination 380 to the right U-shaped connector 162. The upper end of the lower right vertical tube 132 is located within and attached to the lower end 184 of the right U-shaped connector 162 with a nut and bolt combination 380 inserted through the third bore 138 on the right lower vertical tube 132, and through the first bore 164 on the right connector 162 to attach the lower right vertical tube 132 to the right connector 162.

As shown in FIGS. 2, 3, 4, 6 and 7, located at the bottom of the lower left vertical tube 144 is a left U-shaped connector 188 having a first bore 190, a second bore 192, an upper right slot 196, an upper left slot 198, a left pivitor 200, a lower right U-slot 202, a lower left U-slot 204, an upper end 206, a lower end 208 and a left securing latch 210 having a bore therethrough and that is pivotally attached by a nut and bolt combination 380 to the left U-shaped connector 188. The upper end of the lower left vertical tube 144 is located within and attached to the lower end 208 of the left U-shaped connector 188 with a nut and bolt combination 380 inserted through the third bore 150 on the lower left vertical tube 144 and through the first bore 190 on the left connector 188 to attach the lower left vertical tube 144 to the left connector 188.

An upper structure 212 comprises the upper right vertical tube 214, the upper left vertical tube 232, and the upper horizontal tube 248. The upper right vertical tube 232, as shown in FIGS. 1, 2, 3 and 5, has a first bore 216, a second bore 218, a third bore 220, a fourth bore 222, a fifth bore 224 and a sixth bore 226. Extending through the second bore 166 on the right U-shaped connector 162 and through the first bore 216 is a nut and bolt combination 380 that maintains the right securing latch 186 attached to an inner side of the right connector 162. When the right securing latch 186 is in a downward, engaged position, the latch maintains the upper right vertical tube 214 vertically attached to the lower right vertical tube 132.

The upper left vertical tube 232, as shown in FIGS. 1, 2, 3, 4 and 5, has a first bore 234, a second bore 236, a third bore 238, a fourth bore 240, a fifth bore 242 and a sixth bore 244. Extending through the second bore 192 on the left U-shaped connector 188 and through the first bore 234 is a nut and bolt combination 380 that maintains the left securing latch 210 attached to an inner side of the left connector 188. When the left securing latch 210 is in a downward, engaged position, the latch maintains the upper left vertical tube 232 vertically attached to the lower left vertical tube 144.

The upper horizontal tube 248, as shown in FIGS. 1, 2, 3 and 5, is located substantially adjacent the upper ends of the upper right and left vertical tubes 214,232 and has a first end 250 and a second end 252. The first end 250 is attached to the upper right vertical tube 214 and the second end 252 is attached to the upper left vertical tube 232. Located on an upper surface of the upper horizontal tube 248 is an umbrella bracket 258 having a screw size adjuster 260 for adjusting the size of the bracket's opening, and at least one bore 262 into which is inserted a nut and bolt combination 380 that continues through at least one corresponding bore on the upper horizontal tube 248 for securing the umbrella bracket 258 to the tube 248. The umbrella bracket 258 allows an umbrella support tube to be inserted through the bracket for transportation either alone or with other items on said utility cart 10.

The handle assembly 264, as shown in FIGS. 1, 2, 3, 4 and 5, has a handle bar 266, a right handle attachment bracket 268 with an upper tray securing latch 278, and a left handle attachment bracket 288. The handle bar 266 is located between and attached respectively to the right and left attachment brackets 268,288. The right handle attachment bracket 268 has a first bore 270, a second bore 272 and a third bore 274, with a nut and bolt combination 380 inserted through the first and second bores 270,272 and the corresponding fifth and sixth bores on the upper right vertical tube 214. The upper tray securing latch 278 is pivotally attached to the right handle attachment bracket 268 by a nut and bolt combination 380 that is inserted through a bore on the latch 278 and the corresponding third bore 274 on the right handle attachment bracket 268. Secured to and extending from the latch's nut is a cable 282 that maintains a cart securing pin 284 on the cable's distal end. The left handle attachment bracket 288 has a first bore 300, a second bode 302, and a third bore 304, with a nut and bolt combination 380 inserted through the first and second bores 300,302 and the corresponding fifth and, sixth bores on the upper left vertical tube 232.

The removable tray assembly 300, as shown in FIGS. 1-7, has a right side 312 with a right attachment hook 314 and a bore 316, a left side 318 with a left attachment hook 320 and a bore 322, a front side 324 with a lip 326, a rear side 328, a first inner tray surface 332, and a second outer tray surface 352. The first inner tray surface 332 has a right edge 334 with a right grasping tab 336, a left edge 338 with a left grasping tab 340, a front edge 342, and a rear edge 344 with a piano hinge 346 attached thereto. The second outer tray surface 352 has a L-shaped right side 354 with a right securing hook 356, a right grasping tab 358, and a bore 360; a L-shaped left side 362 with a left securing hook 364, a left grasping tab 366, and a bore 368, a front edge 370; and a rear edge 372.

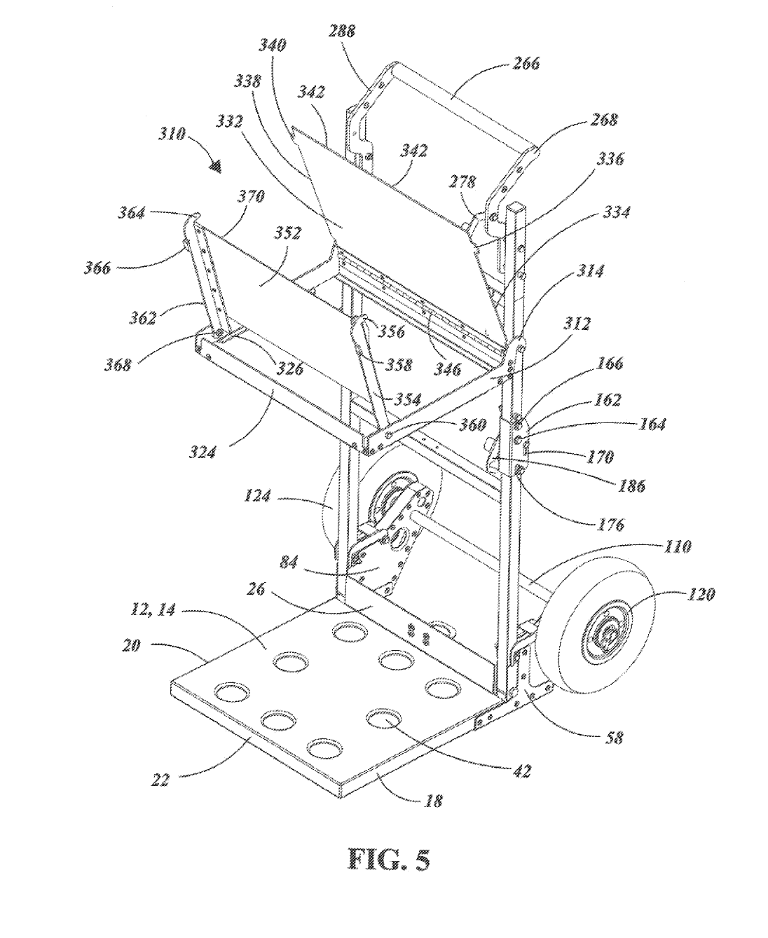

As shown in FIG. 5, the first inner tray surface 332 is attached to the second outer tray surface 352 by the piano hinge 346 such that the first inner surface 332 folds down upon the second outer surface 352. The first inner surface 332 is raised by lifting upward on either or both the right and left grasping tabs 336,340. The tray assembly 300 is removably attached to, at the substantial center of, the upper right and left vertical tubes 214,232, by interfacing the second outer tray surface's right securing hook 356 to a nut and bolt combination 380 that is inserted through the third bore 220 located at the substantial center on the upper right vertical tube 214, and the second outer tray surface's left securing hook 364 to a nut and bolt combination 380 that is inserted through the third bore 238 located at the substantial center on the upper left vertical tube 232. Once the two securing hooks 356,364 interface with the respective nut and bolt combinations 380, the tray assembly 300 is pivotally attached to and extends forward from the upper vertical tubes 214,232.

To collapse the CUC 10 for transportation and storage the following steps are performed:
a) fold the base 12 upwards to a position interfacing with and parallel to the lower structure 130.
b) lift the tray assembly upward and simultaneously fold downward to a position interfacing with and parallel to the upper structure 212,
c) lift the upper structure 212 upward and simultaneously fold downward to a position interfacing with and parallel to the lower structure 130, and
d) insert the cart securing pin 284 which is attached via a cable 282 to the upper structure 212, into a bore located on the lower structure, thereby securing together the folded collapsed components of the CUC 10.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A collapsible utility cart (CUC) comprising a base, an axle and wheel assembly, a lower structure, and an upper structure, wherein said axle and wheel assembly are attached to said base, said base is pivotally attached to said lower structure, and said lower structure is pivotally attached to said upper structure.

2. The CUC as specified in claim 1 wherein said base extends forward perpendicularly from a lower end of said lower structure, wherein said base folds upward to a position interfacing with and parallel to said lower structure.

3. The CUC as specified in claim 1 wherein said lower structure comprise a lower right vertical tube, a lower left vertical tube, and a lower horizontal tube.

4. The CUC as specified in claim 1 wherein said upper structure comprises an upper right vertical tube, an upper left vertical tube, and an upper horizontal tube.

5. The CUC as specified in claim 1 wherein said lower structure is pivotally attached to said upper structure by a right U-shaped connector and a left U-shaped connector, wherein said upper structure folds downward to a position interfacing with said lower structure.

6. The CUC as specified in claim 1 wherein said upper structure further comprises a handle assembly that extends rearward substantially perpendicular from an upper end of said upper structure.

7. The CUC as specified in claim 1 wherein said upper structure further comprising a tray assembly that is pivotally attached to and extends forward perpendicularly from said upper structure, wherein said tray assembly folds upward to a position interfacing with and parallel to said upper structure.

8. The CUC as specified in claim 1 wherein the means for pivotally attaching the components that comprise said cart is comprised of at least one nut and bolt combination.

9. A collapsible utility cart comprising a base, an axle and wheel assembly, a lower structure, an upper structure and a handle assembly, wherein said base having an upper surface and a lower surface, wherein said base is pivotally attached to, and extends perpendicularly from, a lower end of said lower structure, wherein during use said base is in a position parallel to the ground, and for transportation and storage of said cart, said base folds upward to a position interfacing with and parallel to said lower structure, wherein said axle and wheel assembly is located adjacent the lower end of said lower structure and comprises an axle having two wheels with tires attached thereto, wherein said lower structure extends upward from said base and comprises a lower right vertical tube, a lower left vertical tube, and a lower horizontal tube, wherein said upper structure is pivotally attached to, and extends upward from, said lower structure and is comprised of an upper right vertical tube, an upper left vertical tube, and an upper horizontal tube, wherein said handle assembly is pivotally attached to, and extends rearward substantially perpendicular from an upper end of said upper structure and having a handle bar, a right handle attachment bracket, and a left handle attachment bracket, wherein said collapsible utility cart folds into a substantially square, substantially flat structure for transportation and storage of said utility cart.

10. The CUC as specified in claim 9 wherein said base is substantially square shaped.

11. The CUC as specified in claim 9 wherein said base is pivotally attached to said lower structure by a nut and bolt combination inserted through a bore on a right end and a left end.

12. The CUC as specified in claim 9 wherein said lower structure is pivotally attached left end.

13. The CUC as specified in claim 9 wherein said handle assembly is pivotally attached to said upper structure by a nut and bolt combination inserted through at least one bore on a right end and a left end.

14. The CUC as specified in claim 9 further comprising a tray assembly that is removably attached to and pivots from the substantially center of said upper structure, wherein during use said tray assembly extends forward perpendicularly from said upper structure, and for transportation and storage of said cart, said tray is removed from said cart, or said tray pivots upward to a position interfacing with an parallel to the upper half of said upper structure.

15. The CUC as specified in claim 9 wherein said tray is substantially square shaped.

16. The collapsible utility cart as specified in claim 9 wherein to collapse said cart for transportation or storage, the following steps are performed:
a) fold said base upwards to a position interfacing with and parallel to said lower structure.
b) lift said tray upward and simultaneously fold downward to a position interfacing with and parallel to said upper structure,
c) lift said upper section upward and simultaneously fold downward to a position interfacing with and parallel to said lower structure, and
d) insert a cart securing pin which is attached via a cable to said upper structure, into a bore located on said lower structure, thereby securing together the folded components of said cart.

17. A collapsible utility cart for simultaneously transporting a variety of multiple items, wherein said utility cart is collapsible for transportation and storage of said cart, wherein said utility cart comprising:
A. a base having an upper surface, a lower surface, a right edge, a left edge, a front edge and a rear edge, wherein extending upward from and integrally attached to the rear edge is a vertical plate having a right end with a right bend and a bore therethrough, and a left end with a left bend and a bore therethrough, wherein located on and extending through the upper surface of said base is at least one weight reduction opening, wherein extending inward from the vertical plate is a storage bracket having an opening and at least one attachment bore into which is inserted a corresponding nut and bolt combination which extends through the vertical plate,
B. a right axle structure having an inner side plate, an outer side plate and a downward sloping central section wherein the two side plates are configured to create a U-shaped opening, wherein the downward sloping central section is located between and attached to the inner and outer side plates, wherein extending through the inner and outer side plates is at least one axle bore, a first bore, a second bore, and a pin bore, wherein extending through the first bore is a nut and bolt combination that pivotally secures a right lower latch,
C. a left axle structure having an inner side plate, an outer side plate and a downward sloping central section wherein the two side plates are configured to create a U-shaped opening, wherein the downward sloping central section is located between and attached to the inner and outer side plates, wherein extending through the inner and outer side plates is at least one axle bore, a first bore and a second bore, wherein extending through the first bore is a nut and bolt combination that pivotally secures a left lower latch,
D. an axle and wheel assembly comprising an axle having a right end with a bore therethrough and a left end with a bore therethrough, wherein said axle and wheel assembly is located adjacent the lower end of said lower structure, wherein the right end of said axle is inserted through the axle bore on the right axle structure and the left end is inserted through the axle bore on the left axle structure, wherein a right wheel/tire is attached to the axle by inserting the right end through a bore in the center of the right wheel, and inserting a right axle pin, which secures the right wheel/tire through the bore on the right end, wherein a left wheel/tire is attached to the axle by inserting the left end through a bore in the center of the left wheel, and inserting a left axle pin, which secures the left wheel/tire through the bore on the left end,
E. a lower right vertical tube having a first bore, a second bore and a third bore, wherein said lower right vertical tube extends upward from the right side of said base and a lower section of the tube is located in the U-shaped opening created by said right axle structure's two side plates, wherein a nut and bolt combination is inserted through the second bore on said right axle structure and through the first bore on said lower right vertical tube to pivotally attach said tube to said right axle structure,
F. a lower left vertical tube having a first bore, a second bore and a third bore, wherein said lower left vertical tube extends upward from the left side of said base and a lower section of the tube is located in the U-shaped opening created by said left axle structure's two side plates, wherein a nut and bolt combination is inserted through the second bore on said left axle structure and through the first bore on said lower left vertical tube to pivotally attach said tube to said left axle structure, wherein located adjacent the upper ends of said right and left vertical tubes is a lower horizontal tube having a right end and a left end, wherein the right end of the horizontal tube is attached to said right lower vertical tube, and the left end is attached to said left lower vertical tube,
G. a right U-shaped connector having a first bore, a second bore, an upper right slot, an upper left slot; a spacer, a lower right U-slot, a lower left U-slot, an upper end, a lower end, and a right securing latch having, a bore therethrough and that is pivotally attached to said right U-shaped connector, wherein the upper end of said lower right vertical tube is located within and attached to the lower end of said right U-shaped connector with a nut and bolt combination inserted through the third bore on said right lower vertical tube, and through the first bore on said right connector to attach said right vertical tube to said right connector,
H. a left U-shaped connector having a first bore, a second bore, an upper right slot, an upper left slot, a spacer, a lower right U-slot, a lower left U-slot, an upper end, a lower end and a left securing latch having a bore therethrough and that is pivotally attached to said left U-shaped connector, wherein the upper end of said lower left vertical tube is located within and attached to the lower end of said left U-shaped connector with a nut and bolt combination inserted through the third bore on said left lower vertical tube and through the first bore on said left connector to attach said left vertical tube to said left connector,
I. an upper right vertical tube having a first bore, a second bore, a third bore, a fourth bore, a fifth bore and a sixth bore, wherein extending through the second bore on said right U-shaped connector and through the first bore is a nut and bolt combination that maintains the right securing latch attached to an inner side of said right connector, wherein engaged when the right securing latch is in a downward, engaged position, the latch maintains the right upper vertical tube vertically attached to the right lower vertical tube,
J. an upper left vertical tube having a first bore, a second bore, a third bore, a fourth bore, a fifth bore and a sixth bore, wherein extending through the second bore on said right U-shaped connector and through the first bore is a nut and bolt combination that maintains the left securing latch attached to an inner side of said right connector, wherein when the right securing latch is in a downward engaged position, the latch maintains the left upper vertical tube vertically attached to the left lower vertical tube,
K. an upper horizontal tube located substantially adjacent the upper ends of said right and left upper vertical tubes and having a first end and a second end, wherein the first end is attached to said right upper vertical tube and the second end is attached to said left upper vertical tube, wherein located on an upper surface of said upper horizontal tube is an umbrella bracket having a screw adjusted for adjusting the size of the bracket's opening, and at least one bore into which is inserted a nut and bolt combination that continues through at least one corresponding bore on said upper horizontal tube for securing the umbrella bracket to said tube, wherein the umbrella bracket allows an umbrella support tube to be inserted through the bracket for transportation either alone or with other items on said utility cart,
L. a handle assembly having a handle bar, a right handle attachment bracket with an upper tray securing latch, and a left handle attachment bracket, wherein the handle bar is located between and attached respectively to the right and left attachment brackets, wherein the right handle attachment bracket has a first bore, a second bore and a third bore, with a nut and bolt combination inserted through the first and second bores and the corresponding fifth and sixth bores on said upper right vertical tubes, wherein, the left handle attachment bracket has a first bore and a second bore, with a nut and bolt combination inserted through the first and second bores and the corresponding fifth and sixth bores on the upper left vertical tube, wherein the upper tray securing latch is pivotally to the right handle attachment bracket by a nut and bolt combination that is inserted through a bore on the latch and the corresponding third bore on the right handle attachment bracket, wherein secured to and extending from the latch's nut is a cable that maintains a cart securing pin on the cable's distal end, and
M. a tray assembly having a right side with a right attachment hook and a bore, a left side with a left attachment hook and a bore, a front side with a lip, a rear side, a first inner tray surface, and a second inner tray surface, wherein the first inner tray surface has a right edge with a right grasping tab, a left edge with a left grasping tab, a front edge, and a rear edge with a piano hinge attached thereto, wherein the second outer tray surface has a L-shaped right side with a right securing hook, a right grasping tab, and a bore; a L-shaped left side with a left securing hook, a left grasping tab, and a bore, a front edge; and a rear edge, wherein the first inner tray surface is attached to the second outer tray surface by the piano hinge such that the first inner surface folds down upon the second outer surface, wherein the first inner surface is raised by lifting upward on either or both the right and left grasping tabs, wherein said tray assembly is removably attached to said right and left upper vertical tubes, substantially adjacent the lower end of the tubes, by interfacing the second outer tray surface's right securing hook to a nut and bolt combination that is inserted through the third bore on said right upper vertical tube, and the second outer tray surface's left securing hook to a nut and bolt combination that is inserted through the third bore on said left upper vertical tube, wherein once the two securing hooks interface with the respective nut and bolt combinations, said tray assembly is pivotally attached to and extends forward from said upper vertical tubes.

18. The CUC as specified in claim 17 further comprising an umbrella bracket having a screw adjustor, wherein said umbrella bracket is secured to said upper structure by inserting at least one nut and bolt combination through at least one corresponding bore on said bracket and said upper section, wherein said umbrella bracket allows an umbrella rod to be inserted through said bracket, secured by the screw adjustor, and transported along with other items on said cart

19. The CUC as specified in claim 17 further comprising a storage bracket having an opening, wherein said storage bracket is attached to said cart by at least one nut and bolt combination inserted through at least one corresponding bore on said bracket and said art, wherein said storage bracket allows said cart to be hung flat against a wall for storage.

20. A CUC comprising a base, an axle and wheel assembly a lower structure, an upper structure, a handle assembly and a tray assembly, wherein to collapse said cart for transportation and storage the following steps are performed:
a) fold said base upwards to a position interfacing with and parallel to said lower structure.
b) lift said tray assembly upward and simultaneously fold downward to a position interfacing with and parallel to said upper structure,
c) lift said upper structure upward and simultaneously fold downward to a position interfacing with and parallel to said lower structure,
d) fold said handle assembly rearward and downward to a position interfacing with and parallel to said upper structure, and
e) insert the cart securing pin which is attached via the cable to said upper structure, into a bore located on said lower structure, thereby securing together the folded components of said cart.
